(19) United States
(12) Patent Application Publication
(10) Pub. No.: US 2006/0134281 A1
(43) Pub. Date: Jun. 22, 2006

(54) Infusion process

(75) Inventors: Rodney L. Cook, Olympia, WA (US); Neal Hammond, Galt, CA (US)

Correspondence Address: MILLER NASH LLP, 4400 TWO UNION SQUARE, 601 UNION STREET, SEATTLE, WA, 98101-2352, US

(73) Assignee: Producer Marketing Corporation

(21) Appl. No.: 11/016,398

(22) Filed: Dec. 17, 2004

(51) Int. Cl. A23L 1/31

(52) U.S. Cl. 426/281

(57) ABSTRACT

The present invention is directed to an improved fruit infusion process, and more specifically, to an improved blueberry infusion process. Specifically, the present invention is directed to an improved fruit infusion process wherein a plurality of blueberries are placed into a tumbler. A first solution and second solution are added to the tumbler, thereby, along with the plurality of blueberries, forming a blueberry solution. The blueberry solution is processed in the tumbler. In a preferred embodiment, the blueberry solution is processed for at least twenty-four hours. Optionally, the Brix level of the blueberry solution may be tested, and it is preferred that the Brix level of the blueberry solution be at least 70°Brix. The water activity level of the blueberry solution is tested, and preferably, the water activity level is at least 0.65 Aw. The plurality of blueberries are removed from the tumbler and packaged.

### BACKGROUND OF INVENTION

1. Field of Invention The present invention is directed to an improved infusion process, and more specifically, to an improved infusion process for fruits and vegetables.

2. Description of the Related Art

Various studies claim that many small fruit and vegetables, including but not limited to blueberries, raspberries, blackberries, strawberries, grapes, carrots, tomatoes, broccoli, contain a number of substances which may provide significant health benefits to those who consume them. Examples of these substances include, but are not limited to, anthocyanosides, bacterial inhibitors, folic acid, antioxidants such as vitamins A and C, cartenoids, ellagic acid, folic acid, dietary fibers.

Exemplary health benefits of blueberries may include, but are not limited to: (i) protecting the human body against the damaging effects of free radicals and the chronic diseases associated with the aging process; (ii) reducing the build up of so-called “bad” cholesterol, commonly referred to as low-density lipoprotein, which is believed to contribute to cardiovascular disease and strokes; (iii) promoting urinary tract health and reducing the risk of urinary tract infections; and (iv) possibly, easing eye fatigue.

While the health benefits associated with consuming blueberries appear to be limitless, growing blueberries requires fairly specific soil and climactic conditions for maximum production. Thus, only some areas of the world are capable of growing blueberries on a year-round basis. In addition to the difficulty of finding optimal year-round growing conditions, it is difficult, if not impossible, to ship freshly grown blueberries to every location in the world. For example, blueberries grown in, and shipped from, Costa Rica, are unlikely to be fresh by the time they reach an individual in Alaska. Thus, it is not uncommon for individuals to eat dried blueberries instead of fresh blueberries. However, it is understood that dried blueberries: (i) may have a different taste and texture than fresh blueberries; (ii) may not provide the same health benefits as provided by fresh blueberries; and (iii) may not be capable of being used in a wide variety of food applications.

As a result, there are a number of methods and processes known in the industry by which fresh fruit and vegetables may be prepared in order to provide a year-round supply of fruits and vegetables. For example, U.S. Pat. No. 6,254,919 to Phillips (the “'919 patent”) discloses the broad concept of a method for preparing a moist, shelf-stable blueberry product. Specifically, the '919 patent discloses an infusion method having two infusion phases. The blueberries are immersed in a first infusion solution predominantly having a sugar concentration of at least 40°Brix, preferably 40 to 55°Brix. Contact between the blueberries and first infusion solution is typically maintained for 1-3 days, until the internal sugar content of the blueberries is from about 25 to 55°Brix. The blueberries are then immersed in a second solution comprised of sugar solution and an acidulent and antimicrobial agent. Contact is maintained between the blueberries and the second solution until the pH is between 3.0 to 3.4, which typically takes between 1.6 to 3 days. Finally, the blueberries are rinsed and dried until the blueberries have a water activity (Aw) reading between 0.75 to 0.85, with a preferable range of 0.80 to 0.82.

U.S. Pat. No. 6,132,794 to Sinha et al. discloses a process for infusion-drying carrots. The process involves immersing the carrots in an infusion syrup having at least 20% corn syrup, with the remaining percentage, if any, being sugar. The corn syrup is meant to be a mixture of D-glucose, maltose, and maltodextrins prepared by the hydrolysis of cornstarch, utilizing the action of acids or enzymes. The sugar is meant to be a sweetener comprising fructose, sucrose, dextrose, or a mixture thereof. After immersion, the carrots are dried until their Aw is between 0.30 and 0.63.

U.S. Pat. No. 5,840,354 to Baumann et al. discloses sweetened fruit compositions fortified with calcium supplied by calcium phosphate. Fruit solids along with a supplemental carbohydrate ingredient, preferably maltodextrin, are added to calcium salts. The fruit solids and carbohydrate ingredient are blended together. It is preferred that this fruit blend be a homogeneous mass and not in the form of discrete fruit pieces. The fruit blend is then dehydrated and then the calcium salts are added to the mixture. Thereafter, the dried calcium fortified sweetened fruit mixture can be fabricated into suitably sized and shaped individual pieces.

These methods and processes are not optimal in that they do not always work with fresh blueberries. Further, a number of these methods and processes are very application specific, meaning that they do not produce a fruit or vegetable product capable of being used in a wide variety of food applications, including muffin mixes, breakfast cereals, and juices. Additionally, a number of these methods and processes require a significant amount of time and labor in order to complete the method or process. Finally, such methods and processes are not always easily replicated.

### BRIEF SUMMARY OF THE INVENTION

The present invention is directed to an improved infusion process, and more specifically, to an improved infusion process for fruits and vegetables.

Specifically, the present invention is directed to an improved infusion process wherein a plurality of blueberries are placed into a tumbler. A first solution and second solution are added to the tumbler, thereby, along with the plurality of blueberries, forming a blueberry solution. It is preferred that the first solution be a clarified high maltose rice syrup. It is also preferred that the second solution be a combination of fruit essence and preservative.

The blueberry solution is processed in the tumbler. In a preferred embodiment, the blueberry solution may be processed for at least twenty-four hours. Optionally, the Brix level of the blueberry solution may be tested, and, if tested, it is preferred that the Brix level of the blueberry solution be at least 70°Brix. The water activity level of the blueberry solution is tested, and preferably, the water activity level is at least 0.65 Aw. The plurality of blueberries are removed from the tumbler and packaged.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a flowchart illustrating a first preferred embodiment of a fruit infusion process of the present invention.

### DETAILED DESCRIPTION OF THE INVENTION

The present invention is directed to an improved infusion process, and more specifically, to an improved infusion process for fruits and vegetables. The present invention is further directed to a process for infusing fruits and vegetables in an efficient, consistent and time-effective manner for use in a wide variety of food applications.

Although the description and drawings generally describe a method of infusing blueberries, it is to be understood that the present invention describes a process that may be used with any fruit, vegetable, or food product that is capable of being infused. The terms “blueberry” or “blueberries” as used in the description of the invention are for descriptive purposes only and are not intended to limit the scope of the invention.

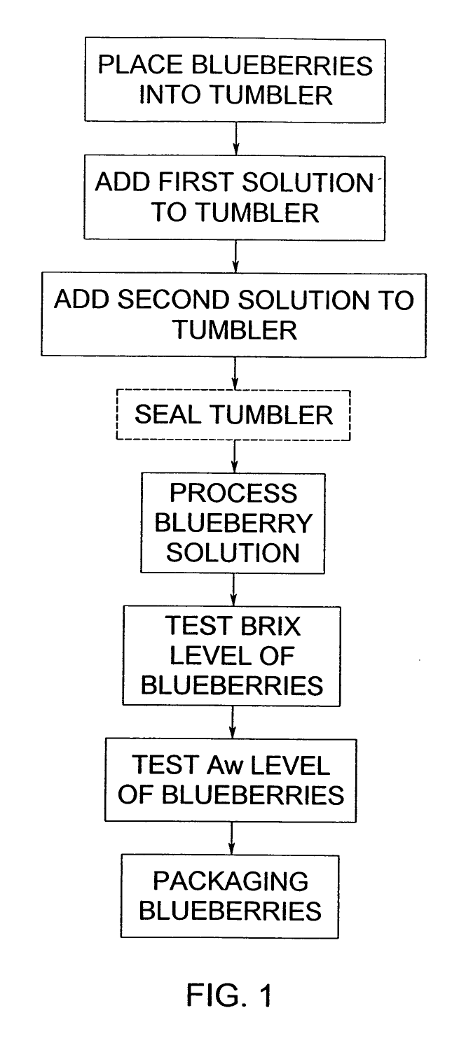

FIG. 1 shows a preferred embodiment of the a fruit infusion process. The process shown in FIG. 1 is an exemplary fruit infusion process and is not the exclusive process used to complete the invention. The first step is placing the blueberries into a tumbler 100. The second step is adding a first solution to the tumbler 200. The third step is adding a second solution to the tumbler 300. The fourth optional step is sealing the vacuum tumbler 400. The fifth step is processing the blueberry solution 500. The sixth optional step is testing the Brix level of the blueberries 600. The seventh step is testing the apparent water activity of the blueberries 700. The eighth step is packaging the blueberries 800. These steps may be performed in alternate orders, additional steps may be included and other steps excluded.

Moving to step 100 of FIG. 1, the blueberries are placed into a machine, vat, container, or tumbler (hereinafter collectively referred to as a “tumbler”). Preferably, the tumbler is capable of rotating and holding vacuums of up to −27 millimeters of mercury. The tumbler may be a vacuum tumbler, although any ordinary tumbler known in the food products or science industry may be used. A vacuum tumbler is preferred as it removes the air from the interior of the tumbler, thereby creating an interior vacuum which allows the blueberries contained in the tumbler to “open up” and be infused with the various substances used in accordance with the present invention. For purposes of this detailed description, reference to a “tumbler” or “vacuum tumbler” will be interchangeable, and no intent to limit the type of tumbler that may be used in connection with this invention should be inferred.

The amount of blueberries loaded into the tumbler is limited only by the capacity of the tumbler itself. However, the exact weight of the blueberries placed into the tumbler should be measured in order to determine the amounts of first and second solution which will be added to the tumbler.

Moving to step 200, a first solution of clarified high maltose rice syrup 22 is added to the tumbler (“first solution”), and specifically, to the blueberries loaded in the tumbler. Clarified high maltose rice syrups are generally made enzymatically from whole rice with a Dextrose Equivalence of 60 or less and are available in a variety of conversions such as clarified low conversion rice syrup, medium conversion rice syrup, and clarified high maltose rice syrup. It is further preferred that the solution of clarified high maltose rice syrup have a sugar concentration of at least 77° Brix.

The purpose of the first solution is to increase the sugar content of the blueberries. This is done by the processing step, which while further discussed below, allows for some water to be removed from the blueberries, thereby allowing for the addition of the first solution into the blueberries. Essentially, the first solution allows for the transfer of sugar content into the blueberries.

The amount of clarified high maltose rice syrup may be added in an amount by weight to the total weight of the blueberries. In a preferred embodiment, the ratio of clarified high maltose rice syrup to blueberries is 4:1 (i.e. four pounds of clarified high maltose rice syrup is added per one pound of blueberries). However, it should be understood that there may be no one specific estimate of first solution to be added to the tumbler. While there are obvious physical limitations (i.e. the size of the tumbler) that limit the amount of the first solution placed in the tumbler, the sugar content of the blueberries will be raised through the addition of the first solution, regardless of the actual amount added.

Moving to step 300 of FIG. 1, a solution of fruit essence and preservative is preferably added to the tumbler (“second solution”).

It should be understood that the fruit essence used in connection with the present invention may vary based on the fruit or vegetable product used in connection with the infusion process of the present invention. However, in a preferred embodiment, the fruit essence is blueberry essence and is distilled from the volatile gases given off during the concentration process of making blueberry juice. The essence is then cut with water to make a commonly known blueberry essence. In a preferred embodiment, the ratio of fruit essence to blueberries is 1:25 (i.e. the fruit essence is added at a rate of four ounces per one hundred pounds of blueberries).

The purpose of the preservative is to bathe the blueberries and first and second solutions in a product not conducive to mold and yeast growth. While any type of food preservative may be used for purposes of the present invention, it is preferred that the preservative be potassium sorbate. It is further preferred that the preservative be generally recognized as a safe substance (i.e. “GRASS status”) by the Food and Drug Administration. In a preferred embodiment, the ratio of preservative to a combination of first solution and fruit essence in the tumbler is one mg/Kg, i.e. the preservative is added to the tumbler at a rate of 1 ppm of weight.

It should be understood that steps 100, 200 and 300 may be accomplished in any order. Further, steps 200 and 300 may be accomplished as one step, meaning that the first solution and second solution are combined and added to the tumbler as one step. Nothing set forth in this detailed description is meant to limit the order in which steps 100, 200 and 300 are accomplished. These steps may be performed in alternate orders, additional steps may be included and other steps excluded.

In optional step 400, if a vacuum tumbler is used in connection with the present process, it is preferred that, following the addition of the first and second solutions to the tumbler, the vacuum tumbler be sealed. One optional method of sealing the vacuum tumbler includes attaching a vacuum pump to the tumbler. After attaching the vacuum pump to the tumbler, the vacuum is preferably pulled in the chamber of the tumbler until the tumbler is sealed. In a preferred embodiment, the vacuum is pulled in the chamber of the tumbler to −27 millimeters of mercury or other such measurement.

Moving to step 500, the blueberries, the first solution and the second solution (“blueberry solution”) contained in the tumbler are processed. In a preferred embodiment, the blueberries and solution are processed by turning the tumbler on to a speed of 2 rpm for a period of twenty-four hours. It should be understood that “turning the tumbler on” means causing the tumbler to rotate. Rotation of the tumbler, and thus, the blueberry solution, allows for the consistent rotation of the first and second solutions throughout the blueberries.

In optional step 600, the Brix level of the blueberries is tested. It is preferred that the Brix level of the blueberries be tested after a period of approximately twenty-four hours from when the blueberry solution was processed. While the Brix level of the blueberries may be checked within the blueberry solution, it is preferred that the first and second solutions be removed from the tumbler before testing the Brix level of the blueberries.

The purpose of testing the Brix level is to determine an estimate of the Brix contained in the blueberries. Once the Brix level is at a certain level, the desired apparent water activity (discussed in detail further below) of the blueberries is likely achieved. It should be understood that there are a plurality of methods for testing the Brix levels of blueberries, and any testing method known in the art may be used in connection with the process of the present invention.

The Brix level of the blueberries is preferably at least 70°Brix. If the Brix level of the blueberries is less than 70°Brix, the tumbler should then be optionally re-sealed and turned on to 2 rpm and processed for a second period of twenty-four hours. If the first and second solutions were removed from the tumbler before testing the Brix level, they should be re-added to the tumbler prior to re-processing the blueberry solution. After a second twenty-four hour period, the Brix level should again be tested. Again, if the Brix level is less than 70°Brix, the tumbler should be optionally re-sealed and turned on to 2 rpm and left for a third period of twenty-four hours. Contact between the first and second solutions and the blueberries should be maintained until the Brix level of the blueberries is at least 70°Brix.

Once the Brix level of the first and second solution is at least 70°Brix, and as shown at step 700, the apparent water activity (Aw) of the blueberries should then be tested.¹ Water activity, commonly referred to as Aw, is the ratio of the vapor pressure of the water contained in the blueberries to the vapor pressure of pure water measured at the same temperature.

Again, there are a number of methods for testing the Aw level of the blueberries, and any known method in the art may be used in connection with testing the Aw of the blueberries infused by the improved infusion process of the present invention. For purposes of the process of the present invention, it is preferred that the Aw level of the blueberries be at least 0.65 Aw. If the Aw level is below 0.65 Aw, the tumbler should then be optionally re-sealed on and turned on to 2 rpm and left for a period of twenty-four hours. If the first and second solutions were removed from the tumblers before testing the Aw level, they should be re-added to the tumbler prior to re-processing the blueberry solution. After a second twenty-four hour period, the Aw level should again be tested. Again, if the Aw level is not at least 0.65 Aw, the tumbler should be optionally re-sealed and turned on to 2 rpm and left for a third period of twenty-four hours. This process is preferably repeated until the Aw level of the blueberries is at least 0.65 Aw.

Once the Aw level is at least 0.65 Aw, the blueberries are preferably removed from the tumbler and from the blueberry solution.² Moving to step 800, as shown in FIG. 1, the blueberries are packaged. Preferably, the blueberries are placed in a holding container, such as a plastic lined corrugated carton, and stored until sold. In an optional embodiment, the tumbler may be the holding container, and the blueberries may be processed, stored, and subsequently sold in the same holding container.

Blueberries prepared in accordance with the present invention may be used in a wide variety of food applications, including muffin mixes, breakfast cereals and juices.

The terms and expressions used in the foregoing specification are used as terms of description and not of limitation, and are not intended to exclude equivalents of the features shown and described or portions of them. The scope of the invention is defined and limited only by the claims that follow.

What is claimed is:

1. An improved fruit infusion process, said process comprising:
(a) placing a plurality of blueberries into a tumbler;
(b) adding a first solution to said tumbler;
(c) adding a second solution to said tumbler, said plurality of blueberries, said first solution and second solution forming a blueberry solution;
(d) processing said blueberry solution;
(e) testing a water activity level of said blueberry solution;
(f) removing said plurality of blueberries from said blueberry solution; and
(g) packaging said plurality of blueberries.

2. The method of claim 1, wherein said first solution is a clarified high maltose rice syrup.

3. The method of claim 1, wherein said second solution is a combination of a fruit essence and a preservative.

4. The method of claim 1, said method further including sealing said tumbler prior to processing said blueberry solution.

5. The method of claim 1, said method further including testing said Brix level of said blueberry solution after processing said blueberry solution and prior to testing said water activity level of said blueberry solution.

6. The method of claim 5, wherein said blueberry solution is processed until said Brix level of said blueberry solution is at least 70°Brix.

7. The method of claim 1, said removing said plurality of blueberries from said blueberry solution occurring after said water activity level is at least 0.65 Aw.

8. The method of claim 1, said method further including processing said blueberry solution for twenty-four hours.

9. A plurality of infused fruit, wherein said plurality of infused fruit are prepared by a process comprising:
(a) placing a plurality of fruit into a tumbler;
(b) adding a first solution to said tumbler;
(c) adding a second solution to said tumbler, said plurality of fruit, said first solution and second solution forming a fruit solution;
(d) processing said fruit solution;
(e) testing a water activity level of said fruit solution;
(f) removing said plurality of fruit from said blueberry solution; and
(g) packaging said plurality of fruit.

10. The plurality of infused fruit of claim 9, wherein said infused fruit is vegetables.

11. An infused fruit having a Brix level of at least 70°Brix and at least an Aw of at least 0.65.
